(19) United States
(12) Patent Application Publication
(10) Pub. No.: US 2010/0025954 A1
(43) Pub. Date: Feb. 4, 2010

(54) PORTABLE SERVICE ACCESSORY FOR A TRUCK TRACTOR

(76) Inventors: George Gottlinger, Tucson, AZ (US); Jay Price, Salt Lake City, UT (US)

Correspondence Address: THE LUTHER LAW FIRM, PLC, 10575 N 114TH STREET, SUITE 103, SCOTTSDALE, AZ, 85259, US

(21) Appl. No.: 12/489,374

(22) Filed: Jun. 22, 2009

Related U.S. Application Data
(60) Provisional application No. 61/074,613, filed on Jun. 21, 2008.

(51) Int. Cl. B60R 3/00

(52) U.S. Cl. 280/166

(57) ABSTRACT

Tractor engine compartment service accessory, optionally portable, preferably permanently installed in engine compartment, has a mounting for attachment to the tractor frame and attached thereto a catwalk and top step extending laterally, the top step resting on the uppermost tread portion of the tractor tire. One or more steps are suspended beneath the top step. A handrail is optionally secured to the top step and a suspended step. The suspended steps may be retracted and nested beneath the top step. The top step may be folded, slid, or otherwise moved to a position above or beneath the catwalk. The catwalk may be rotated upward. The handrail may be disengaged and detached, or it may be rotated to a compact orientation, as needed.

This application claims the benefit of prior co-pending application Ser. No. 61/074,613, filed Jun. 21, 2008, by inventors Gottlinger, G., and Price, J., entitled PORTABLE SERVICE ACCESSORY FOR A TRUCK TRACTOR, which is hereby incorporated by reference.

### TECHNICAL FIELD

This invention is in the field of ladders to provide safe access to track trailer motors.

### BACKGROUND

Maintenance of tractor trailer engines and other equipment housed in an engine compartment of a tractor is required for reliable and durable performance. Fluids levels and pressures, belts, hoses, fuel vents and the like are checked. These activities and others for which a person climbs onto the tractor and reaches into its large, elevated engine compartment would be less hazardous and more convenient if assisted by a convenient accessory facilitating the climbing and reaching.

### SUMMARY

In accordance with the present invention, an exemplary embodiment of a service accessory for a truck tractor has a mounting for attachment to a structure of the tractor; a catwalk extending laterally from the mounting; a top step extending laterally from the catwalk and capable of resting atop a tire of a wheel of the tractor; and at least one step suspended from the top step. The mounting, catwalk, top step, and at least one suspended step are linked such that the at least one suspended step is easily raised and nested beneath the top step. The top step is configurable to an orientation above and adjacent to the catwalk to enable the tractor cab to be lowered. The catwalk is configurable to an orientation above the mounting, to further reduce the space occupied by the accessory, thereby avoiding interference with objects inside the tractor engine compartment.

The service accessory may have its steps linked together in a manner limiting the range of rotation of at least one suspended step in a manner preventing the step from opening to an angle beyond approximately horizontal while suspended. Otherwise, a person ascending the steps might slip off.

The service accessory may have its range of rotation of at least one of at least one steps limited by mechanical interference between a dowel pin and a shoulder.

Also in accordance with the present invention, an exemplary embodiment of a service accessory for gaining access to an engine compartment of a truck tractor has a substantially flat and substantially level portion supported inboard by a structural member of the tractor and supported outboard by a tire of the tractor. At least one step is suspended from the level portion. Together, the level portion and at least one step are configurable to permit closure of the engine compartment of the tractor and normal operation of the tractor.

### BRIEF DESCRIPTION OF THE DRAWINGS

For a further understanding of the objects and advantages of the present invention, reference should be made to the following detailed description, taken in conjunction with the accompanying drawing, in which like parts are given like reference numbers and wherein:

FIG. 1 shows a perspective view of an exemplary embodiment of a portable service accessory for servicing trailers in accordance with the present invention;

FIG. 2 through FIG. 6 show perspective, top plan, bottom plan, side elevational, and rear elevational views, respectively, of a second exemplary embodiment of the portable service accessory in accordance with the present invention;

FIG. 7 shows an exploded perspective view of a third exemplary embodiment of the portable service accessory in accordance with the present invention;

FIG. 8 shows a perspective view of a fourth, preferred, exemplary embodiment of a service accessory in accordance with the present invention approximately positioned in relation to a simplified depiction of a tractor tire;

FIG. 9 shows an exploded perspective view of the embodiment of FIG. 8;

FIG. 10 shows a perspective view of the mounting of the embodiment of FIG. 8;

FIG. 11 shows a perspective view of the catwalk of the embodiment of FIG. 8;

FIG. 12 shows a perspective view of the top step of the embodiment of FIG. 8;

FIG. 13 shows a perspective view of the middle step of the embodiment of FIG. 8;

FIG. 14 shows a perspective view of the bottom step of the embodiment of FIG. 8;

FIG. 15 shows a perspective view of the handrail of the embodiment of FIG. 8;

FIG. 16 shows a perspective view of a fifth exemplary embodiment of the service accessory in accordance with the present invention;

FIG. 17 shows a perspective view of the embodiment of FIG. 16 with small step nested beneath large step;

FIG. 18 shows a perspective view of the embodiment of FIG. 16 with large step nested beneath catwalk;

FIG. 19 shows a perspective view of the embodiment of FIG. 16 with steps rotated upward between gussets;

FIG. 20 shows a plan view of the top step of the embodiment of FIG. 8;

FIG. 21 shows a plan view of the middle step of the embodiment of FIG. 8;

FIG. 22 shows a plan view of the bottom step of the embodiment of FIG. 8;

FIG. 23 shows an elevational view of an upper angle arm of the embodiment of FIG. 8;

FIG. 24 shows an elevational view of a lower angle arm of the embodiment of FIG. 8; and

FIG. 25 shows an elevational view of a straight angle arm of the embodiment of FIG. 8.

### DETAILED DESCRIPTION OF THE PREFERRED EMBODIMENTS

### First Exemplary Embodiment

The portable step is easy and simple to operate. It is durable and designed to support even husky truck operators. It provides a substantially flat, rigid, horizontal platform extending into the engine compartment of a tractor at a convenient height for working on the tractor. Two substantially vertical rails depend from the platform and extend toward the floor beside the tractor. Two steps extend from the rails to enable a person to climb up onto the platform.

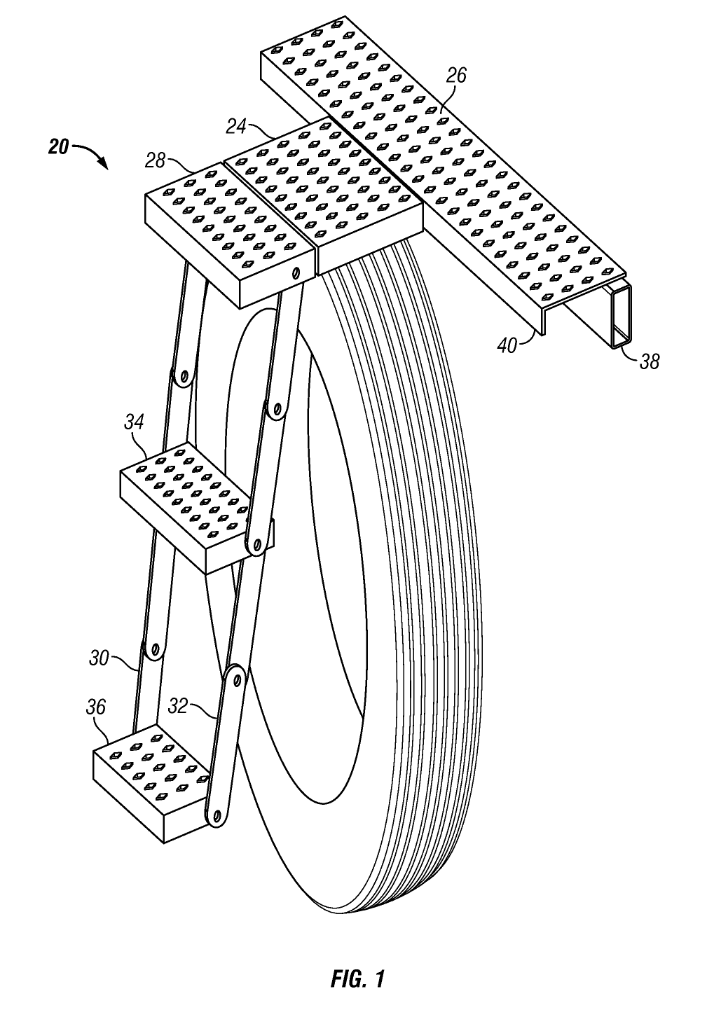

FIG. 1 shows a perspective view of an exemplary embodiment of the portable service accessory in accordance with the present invention shown generally at 20, floating in space with the front tire 22 of the tractor shown to provide a frame of reference for location and orientation. The portable service accessory has a roughly T-shaped platform 24 (also referred to as a “catwalk”) having a longitudinal platform portion 26, a lateral platform portion 28, a first rail 30, a second rail 32, a first step 34, a second step 36, a beam 38, and a flange 40.

The longitudinal platform portion 26 and lateral platform portion 28, here shown finished in anti-skid knurling or other surface features, together provide a surface for standing, crawling, leaning, or kneeling while working on the tractor. The beam 38 and flange 40 depend from the longitudinal platform portion 26 and are mutually parallel and are configured so that an engine compartment frame component or other portion of the tractor, not shown in the figure, may fit between them, stably supporting the longitudinal platform 26. Thus, the beam 38 and flange 40 project downward from the longitudinal platform portion 26 and extend toward one or more components of the tractor while being laterally separated to stably engage those components of the tractor. The lateral platform portion 28 is shown extending over the tire 22. Optionally, although not necessarily, the tire 22 may provide additional support by contacting the lateral platform portion 28. A person using the portable service accessory 20 would place it above the appropriate potion of the tractor or tractor engine frame, seat the longitudinal platform portion on that component, briefly test the steps 34 and 36 by resting a foot thereon, and then climb up onto the platform portion 24.

The above-identified parts of the portable service accessory are joined conventionally by bolts and nuts, by welding, by heavy-duty rivets, or by other standard means, and are formed conventionally of steel, aluminum, composite, wood, or other material suitable for making ladders, steps, rails or the like. Optionally, the steps 34 and 36 are joined to the rails 30 and 32 in a manner allowing them to fold upward for convenient storage and carrying, yet stopping them in a substantially horizontal orientation when unfolded from the rails 30 and 32, so as to reliably bear the load of being climbed on. Similarly, the rails 30 and 32 may be joined to the lateral platform portion 28 in a manner allowing them to be folded, simply or accordion-style, under the platform portion 24 for convenient storage and carrying.

### Second Exemplary Embodiment

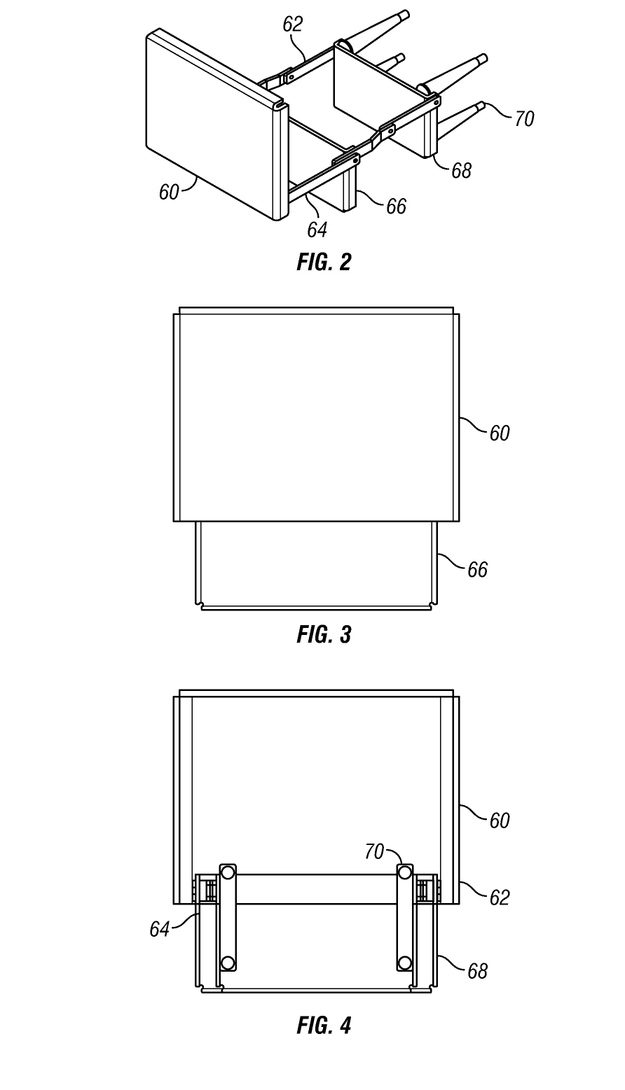

FIGS. 2-6 illustrate another exemplary embodiment of a portable service accessory 20 in accordance with the present invention. FIG. 2, a perspective view, shows a platform 60, a first rail 62, a second rail 64, a first step 66, a second step 68, and four legs 70.

FIG. 3, a top plan view, shows only the platform 60 and first step 66, the other parts being obscured by these.

FIG. 4, a bottom plan view, shows the four legs 70 extending from beneath the second step 68. Also partly visible are the rails 62 and 64 and the platform 60.

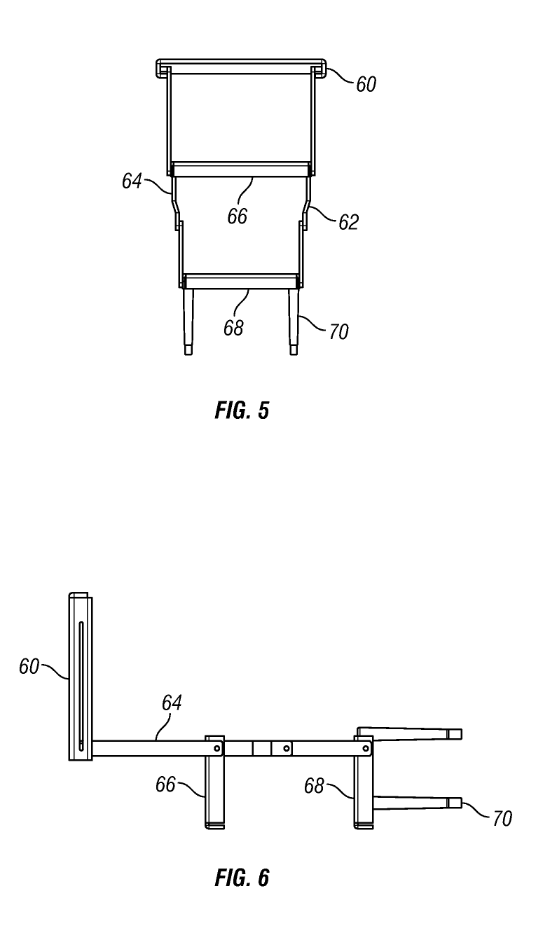

FIG. 5, a side elevational view, shows the platform 60, rails 62 and 64, steps 66 and 68, and two of the four legs 70.

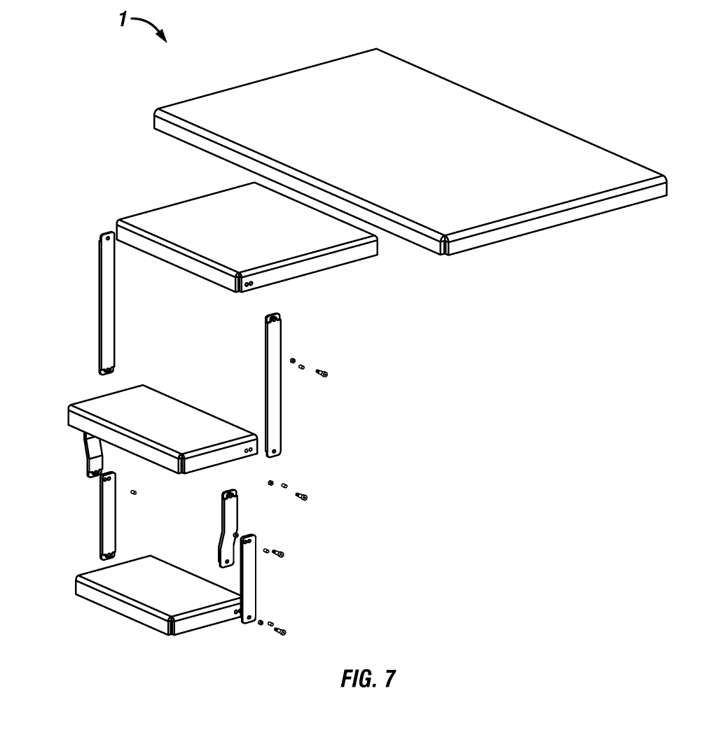

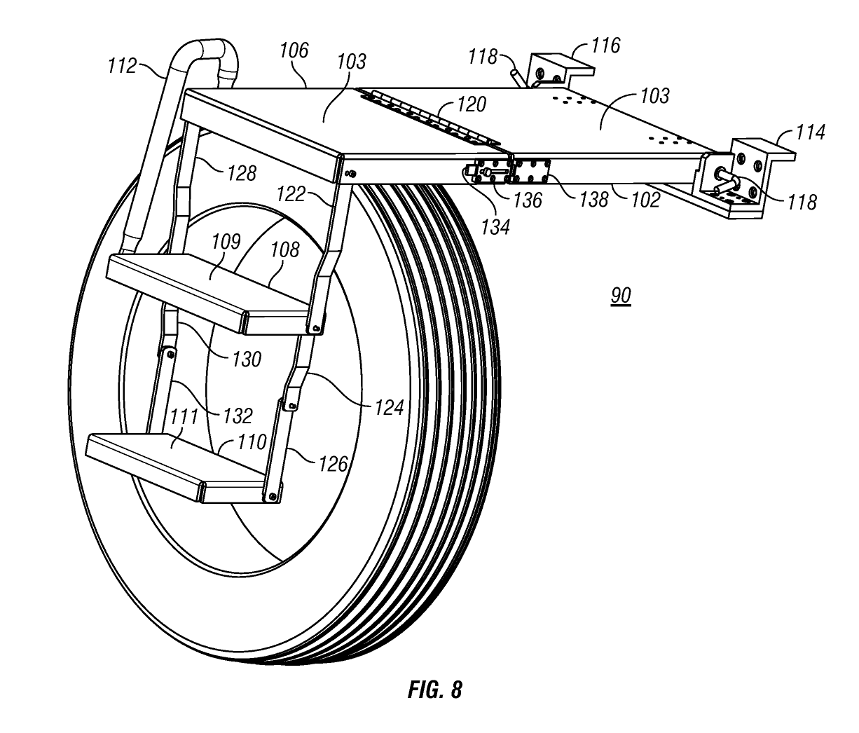

FIG. 6, a rear elevational view (of the accessory as it would be placed at the left side of a tractor), shows the platform 60, one rail 64, the steps 66 and 68, and two of the four legs 70.

The legs 70 are conventionally secured to the second step 68, and the steps 66 and 68, rails 62 and 64, and platform 60 are conventionally joined together, as stated with reference to the embodiment of FIG. 1, with the exception that it is not practicable to mount the legs 70 rotatably or foldably unless they are provided with a locking pin or the like to secure them when they are bearing a load.

Depending on the configuration of the tractor, the beam 38 and flange 40 stabilize the platform 22 a fixed distance from the tractor, thereby spacing the steps and rails away from any painted or easily defaced portions of the tractor body, such as the wheel wells. Optionally, the beam and flange may be replaced with a plurality of beams, securable to the platform in a plurality of lateral positions, thereby providing a way to control the space between the tractor and the rails.

The embodiment of FIGS. 2-6 rests on the floor via legs 70, whereas the embodiment of FIG. 1 rests primarily on the tractor engine frame or tire.

### Third Exemplary Embodiment

The embodiment of FIG. 7 shows a manner in which the parts are provided and joined.

It will be appreciated that the accessory in accordance with the present invention provides stable support for a person, while in at least one embodiment being easily storable and in all embodiments being relatively light, portable and compact.

### Fourth, Preferred Exemplary Embodiment

FIG. 8 shows a perspective view of a fourth, preferred exemplary embodiment of the service accessory in accordance with the present invention approximately positioned in relation to a simplified depiction of a tractor tire, shown generally at 90, comprising a catwalk 102 having a catwalk upper surface 103; a mounting 104 having a right attachment bracket 114 and a left attachment bracket 116; a top step 106 having a top step upper surface 107; a middle step 108 having a middle step upper surface 109; a bottom step 110 having a bottom step upper surface 111. A hand rail 112 is attached to the left sides of the top step 106 and the middle step 108. An L-pin 118 extends inwardly through the mounting 104 proximate each of the right attachment bracket 114 and the left attachment bracket 116 and engages the catwalk 102. A hinge 120 is attached to a frontal portion of the catwalk upper surface 103 and extends laterally most of the width of the catwalk 102. A right upper angle arm 122 connects the middle step 108 to the top step 106. A right lower angle arm 124 and a right straight arm 126, and a left lower angle arm 130 and a left straight arm 132 connect the bottom step 110 to the middle step 108. Left and right lock receivers 136 carrying left and right slide locks 134 are attached to the top step 106. Left and right lock plates 138 are attached to the catwalk 102. The slide locks 134 are longitudinally movable to engage and disengage the lock plates 138.

With continued reference to FIG. 8, the hinge 120 rotatably attaches the top step 106 to the catwalk 102 and allows the top step 106 to be lifted upward and rotated 180° to a folded position in which the top step upper surface 107 is in contact with the catwalk upper surface 103. The slide locks 134 are manually operable to engage the lock plates 138 to stabilize the top step 106 roughly in-plane with the catwalk 102. A person may grasp the handrail 112, climb up the service accessory 90 and crawl on the catwalk 102 to reach the engine compartment of the tractor.

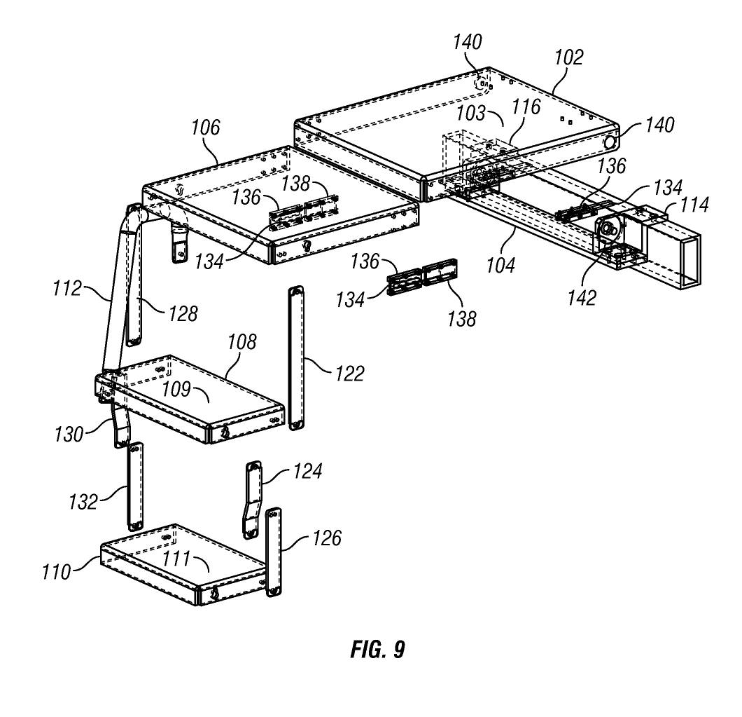

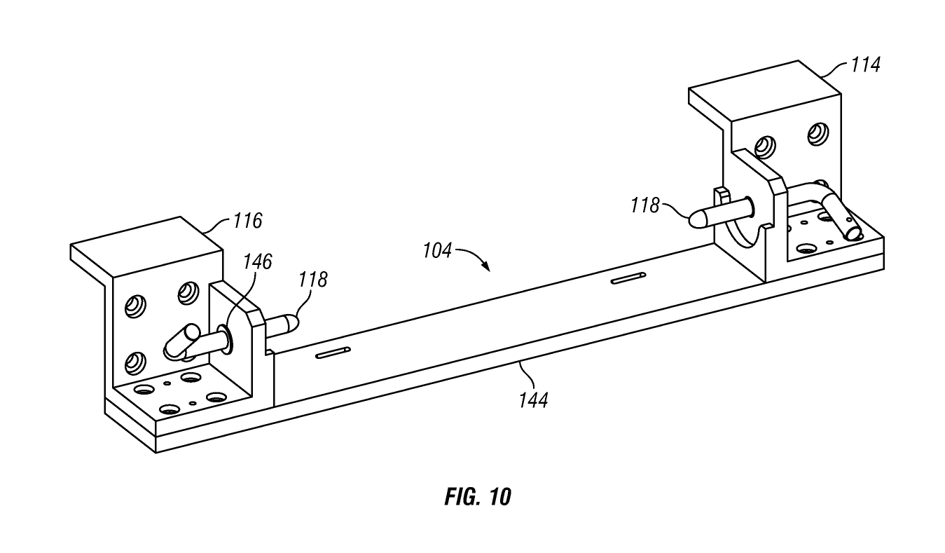

FIG. 9, an exploded view of the embodiment of FIG. 8, shows the catwalk 102, catwalk upper surface 103, mounting 104, right attachment bracket 114, left attachment bracket 116, top step 106, top step upper surface 107, middle step 108, middle step upper surface 109, bottom step 110, bottom step upper surface 111, hand rail 112, hinge 120, right upper angle arm 122, right lower angle arm 124, right straight arm 126, left lower angle arm 130, left straight arm 132, lock receivers 136, slide locks 134, and lock plates 138. A bore 140 is shown located laterally and posteriorly left and right in the catwalk 102. A catwalk bushing 142 is shown aligned inward of each mounting bushing 146 (see FIG. 10) for penetration by respective L-pins 118 to secure the catwalk 102 to the mounting 104. Two additional lock receivers 136 with slide locks 134 are attached to the catwalk 102 and are downwardly exposed for engagement to stabilize the catwalk 102 relative to the mounting 104 and the tractor structure the mounting 104 is attached to.

FIG. 10, a perspective view of the mounting 104 of the embodiment of FIG. 8, shows a mounting lock plate 144 extending between the right attachment bracket 114 and the left attachment bracket 116 and a mounting bushing 146 guiding each L-pin 118 penetrating the mounting 104. The right attachment bracket 114 and the left attachment bracket 116 are bored to be secured by bolts (not shown) for securing the mounting 104 to a structural member of a tractor (not shown).

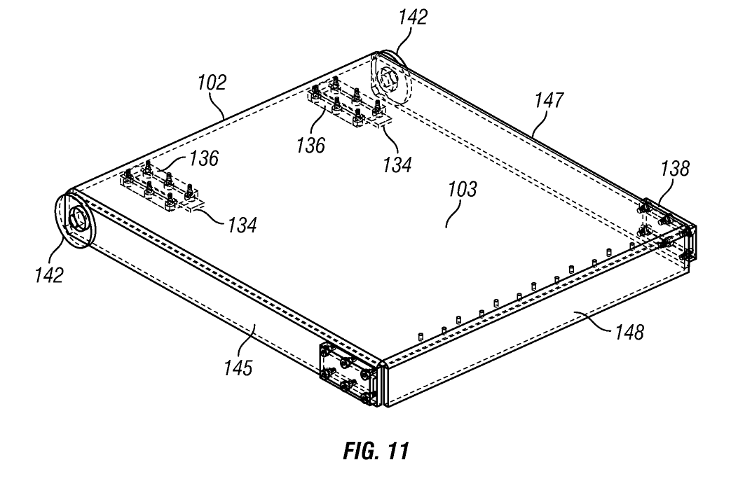

FIG. 11, a perspective view of the catwalk 102 of the embodiment of FIG. 8, shows the catwalk upper surface and two lock receivers 136 with locks 134. Also shown are a catwalk left side 145, a catwalk right side 147, and a catwalk front 148. The catwalk bushings 142 are shown press fitted into the bores 140 of the catwalk 102 in this figure, ready to receive the L-pins 118. Two additional lock receivers 136 with slide locks 134 are attached to the catwalk 102 and are exposed beneath the catwalk 102 and manually accessible and operable for sliding rearward engagement with the upper surface of the tractor structure the mounting 104 is attached to. This serves to stabilize the catwalk 102 by resisting upward rotation of the catwalk relative to the mounting 104 until the slide locks 134 are disengaged, i.e., withdrawn toward the catwalk front 148. As a result, the top step 106 resists upward displacement from its position resting on the tread portion of the tractor tire, reducing the likelihood of accidents occasioned by impact or torque applied to the accessory 90.

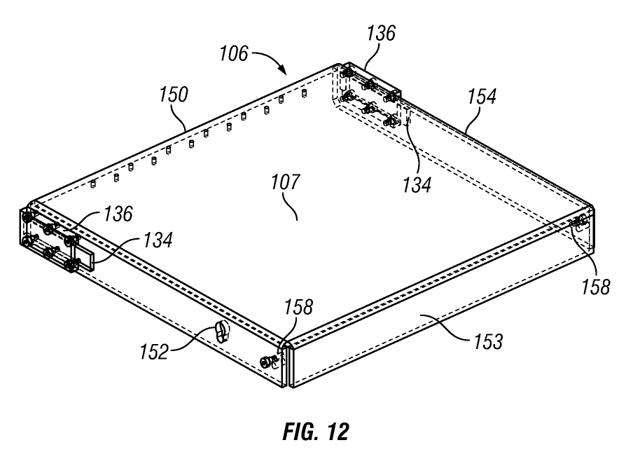

FIG. 12, a perspective view of the top step 106 of the embodiment of FIG. 8, shows a top step rear 150, a top step left side 152 having the lock receiver 136 with slide lock 134, a top step keyhole bore 156, a top step front 153, and a top step right side 154, also having lock receiver 136 with slide lock 134. Inwardly-extending shoulder bolts 158 are attached to the top step left side 152 and the top step right side 154 proximate the top step front 153.

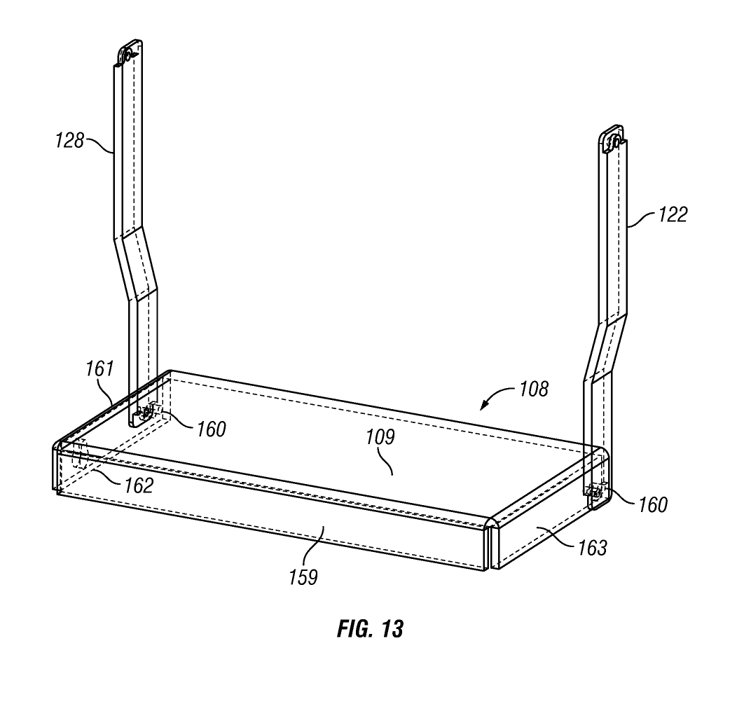

FIG. 13, a perspective view of the middle step 109 of the embodiment of FIG. 8, shows the middle step upper surface 109, a middle step front 159, a middle step left side 161 having an inwardly extending dowel pin 160 for linkage to the right upper angle arm 122, a middle step right side 163 having an inwardly extending dowel pin 160 for linkage to the left upper angle arm 128, and a middle step keyhole bore 162 formed in the middle step left side 161 proximate the middle step front 159 to engage the handrail 112.

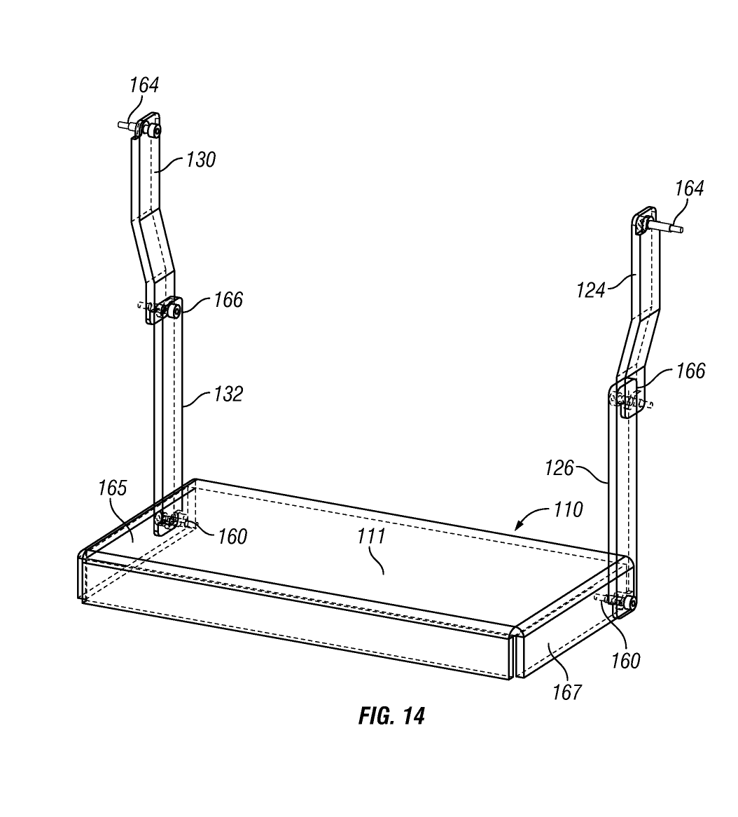

FIG. 14, a perspective view of the bottom step 110 of the embodiment of FIG. 8, shows the bottom step upper surface 111, a bottom step left side 165 having an inwardly extending bottom step shoulder bolt 164 for linkage to the left straight arm 132, which is itself linked to the left lower angle arm 130 by a straight arm shoulder bolt 166; a bottom step right side 167 having an inwardly extending bottom step shoulder bolt 164 for linkage to the right straight arm 126, which is itself linked to the right lower angle arm 124 by a straight arm shoulder bolt 166.

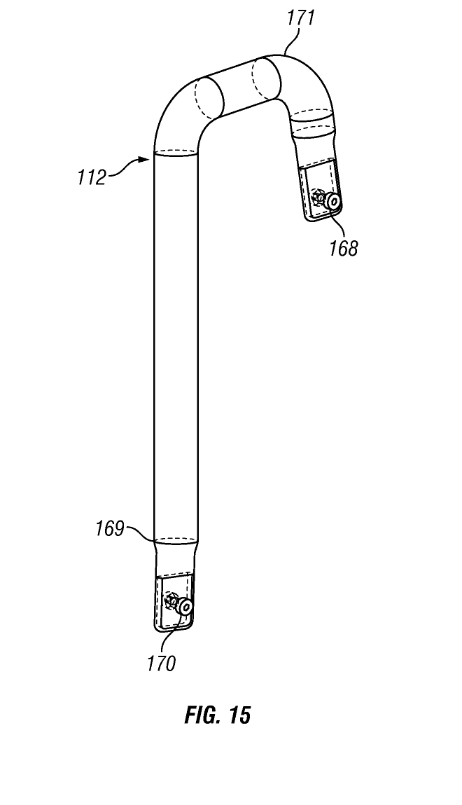

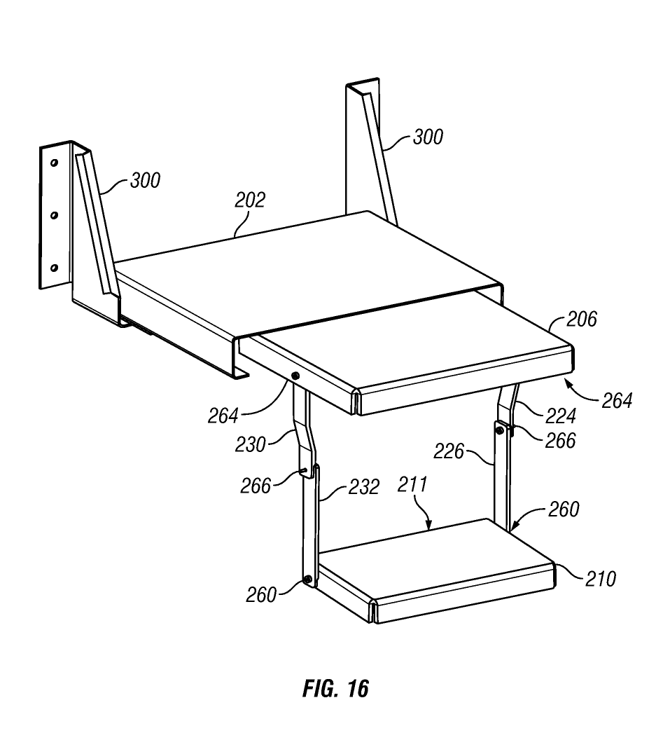

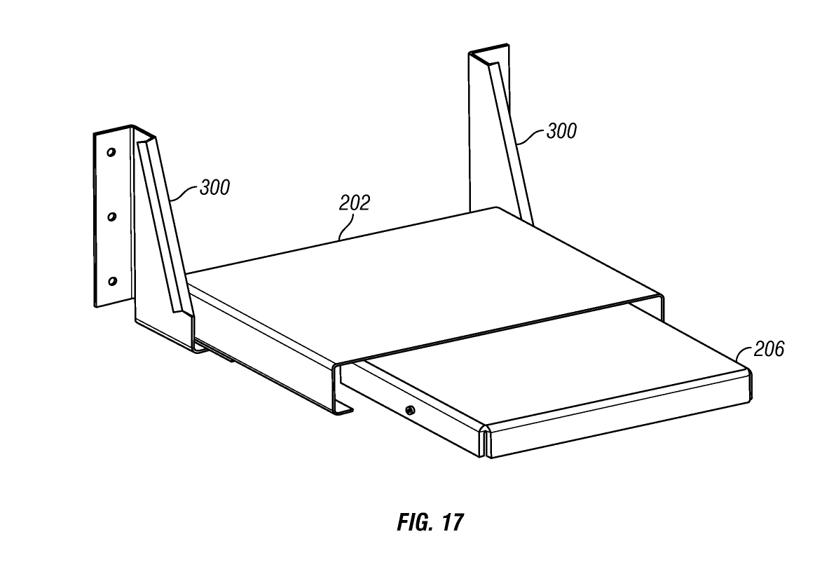

FIG. 15, a perspective view of the handrail of the embodiment of FIG. 8, shows the handrail 112 having a handrail long end 169 with an inwardly extending lock nut 170 for engagement with the middle step keyhole bore 162 (FIG. 13), a handrail crook end 171 with inwardly extending lock stud 168 for engagement with the top step keyhole bore 156 (FIG. 12).

With reference to the bottom step 110, attachment to the left and right straight arms 132 and 126 provides mechanical interference between a machined surface of the straight arms 132 and 126 and the bottom step 110. The equivalent is true of the middle step 108. This interference prevents the middle step 108 and the bottom step 110 from swinging downward a load is applied. Otherwise, a person attempting to ascend the service accessory would slip off.

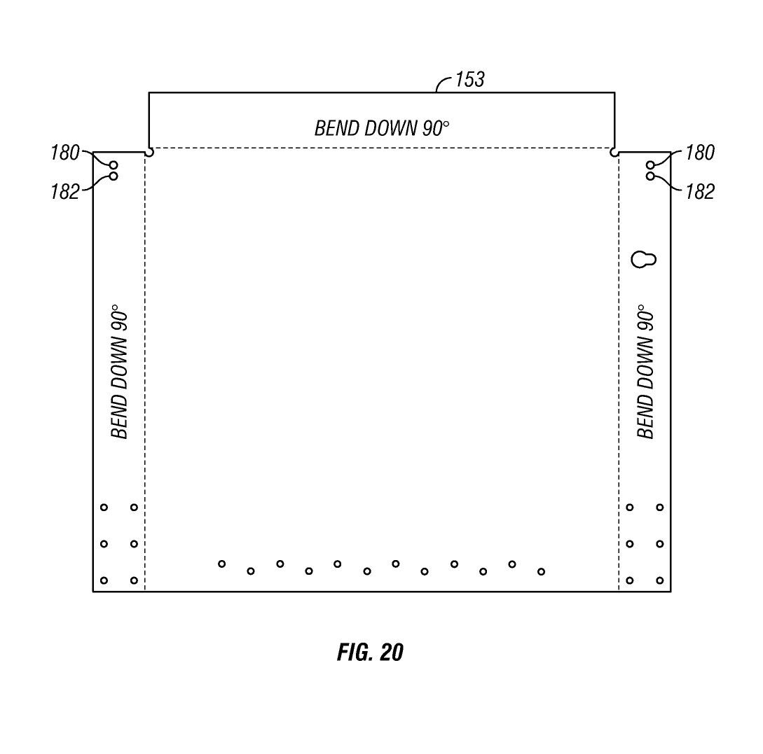

FIG. 20, a plan view of the top step 106 of the embodiment of FIG. 8, shows two press fit dowel pins 180, one of them in each top step side 152 and 154 proximate the top step front 153, and an arm bore 182 proximate each press fit dowel pin 180 and slightly more distant from the top step front 153.

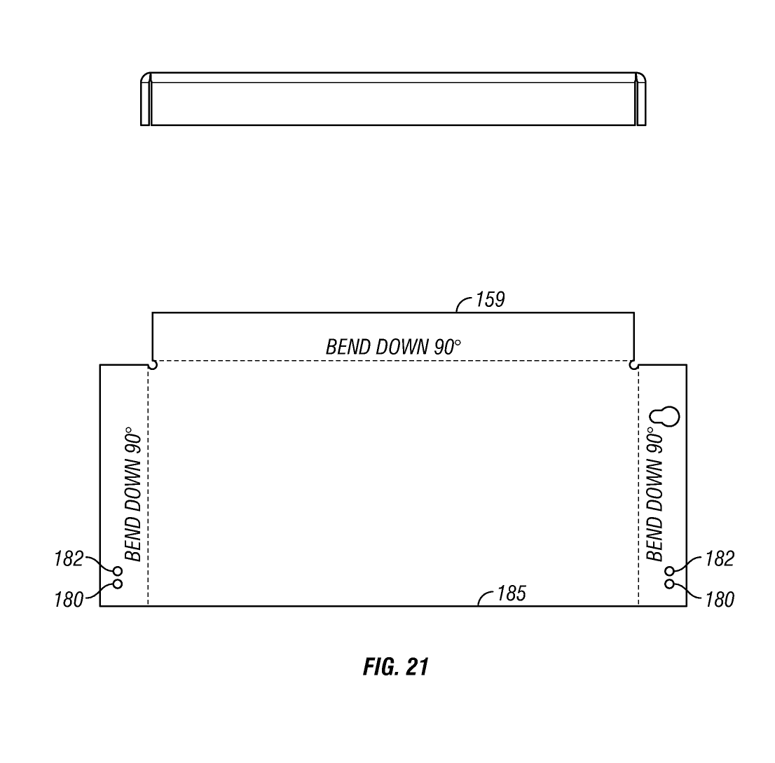

FIG. 21, a plan view of the middle step 108 of the embodiment of FIG. 8, shows two press fit dowel pins 180 proximate the middle step rear 185, and an arm bore 182 proximate each press fit dowel pin 180 and slightly more distant from the middle step rear 185.

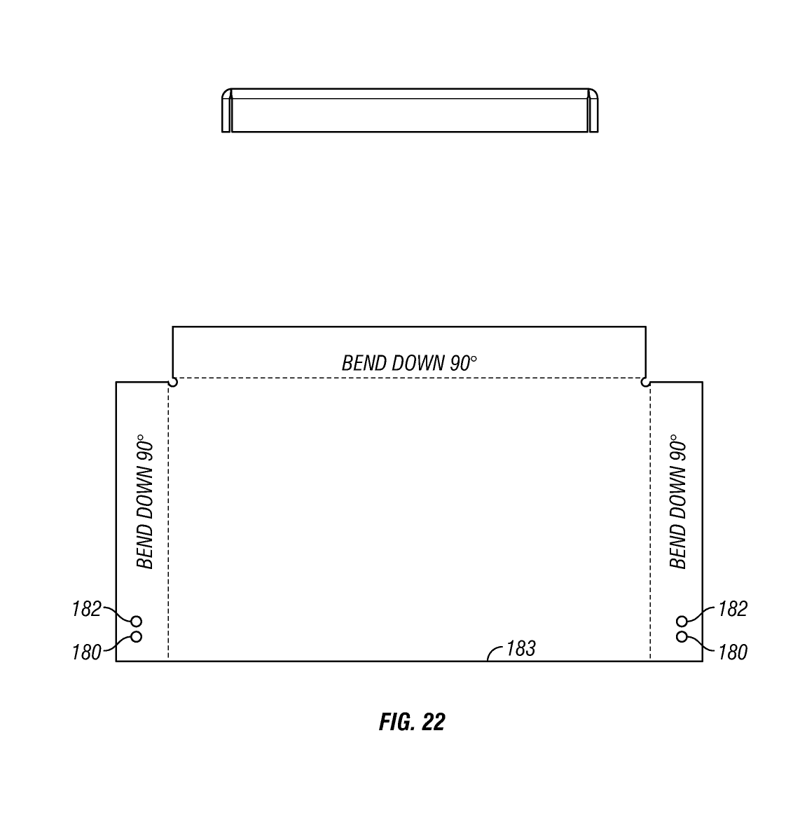

FIG. 22, a plan view of the bottom step 110 of the embodiment of FIG. 8, shows two press fit dowel pins, one of them in each bottom step side 165 and 167 proximate the bottom step rear 183, and an arm bore proximate each press fit dowel pin 180 slightly more distant from the bottom step rear 183.

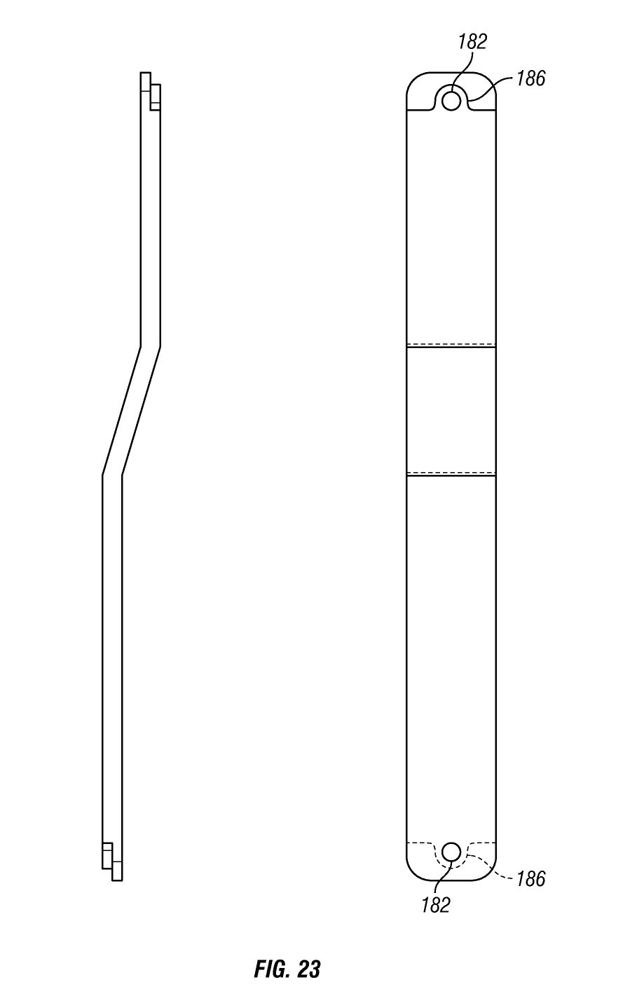

FIG. 23, an elevational view of an upper angle arm 122 or 128 of the embodiment of FIG. 8, with two arm bores 182 and a shoulder 186 proximate each arm bore 182.

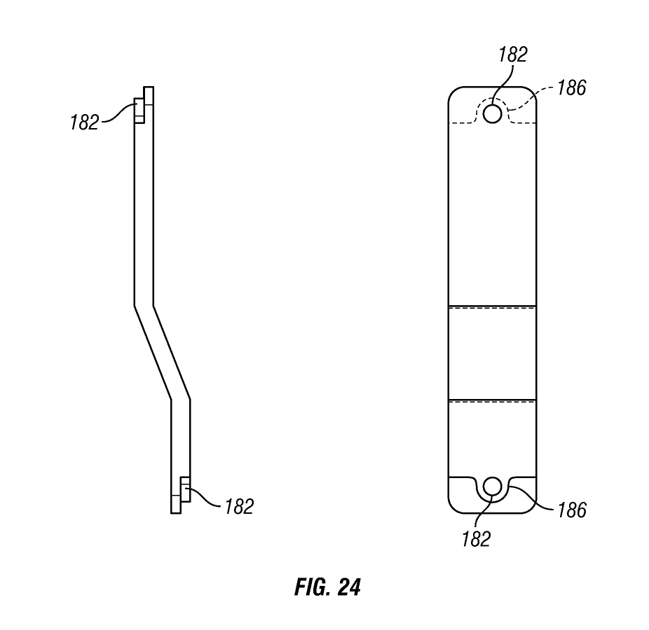

FIG. 24, an elevational view of a lower angle arm 124 or 130 of the embodiment of FIG. 8, shows the lower angle arm 124 or 130 with two arm bores 182 and a shoulder 186 proximate each arm bore 182.

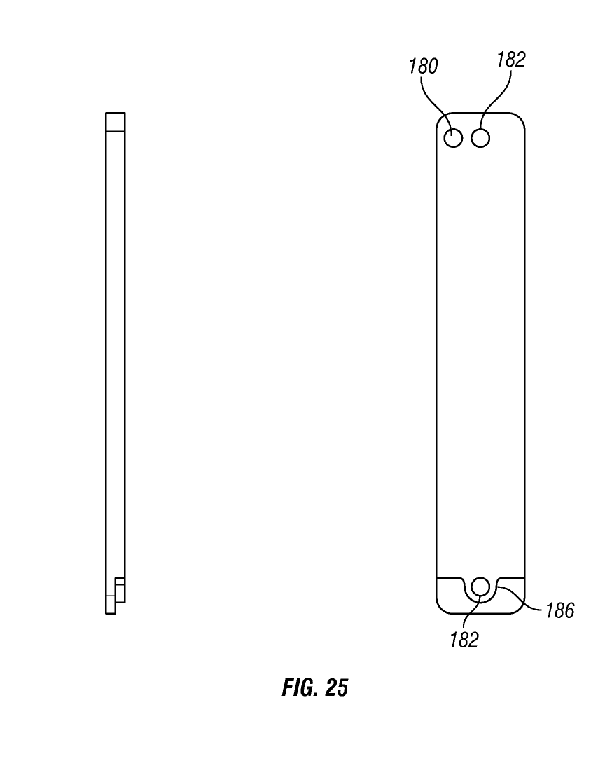

FIG. 25, an elevational view of a straight angle arm of the embodiment of FIG. 8, shows a straight arm 126 or 134 with two centerline arm bores 182, a press fit dowel pin 180 laterally offset proximate one arm bore 182, and a shoulder 186 proximate the opposite arm bore 182.

With reference to FIGS. 23, 24 and 25, handedness matters and separate plans are drawn for left and right.

Also with reference to FIGS. 23, 24 and 25, when an arm is linked to a step or to another arm at aligned arm bores 182, one of the linked structures will have a shoulder 186 and the other will have a press fit dowel pin 180 or similar structure positioned to engage the shoulder, thereby limiting the rotational range of the linkage as needed, for example, to prevent a step 108 or 110 from rotating downward past its load-bearing orientation.

With reference to FIGS. 12, 13 and 15, the top step keyhole bore 156 (FIG. 12) is oriented to trap the lock stud 168 (FIG. 15) when the handrail 112 is forced downward relative to the top step 106. The handrail 112 remains secured to the top step 106 when grasped and leaned on by a person climbing onto the tractor. The middle step keyhole bore 162 (FIG. 13) is oriented to trap the lock nut 170 when the middle step 108 is forced downward relative to the handrail 112 and will remain so engaged when weight is applied to the middle step 108. The handrail 112 may be disengaged from the middle step 108 by lifting and rotating the middle step 108 upward so that the lock nut 170 can clear the middle step keyhole bore 162, and gently moving the handrail long end 169 leftward. Alternatively, the handrail 112 may be disengaged from the top step 106 instead of from the middle step 108, by gently moving the handrail crook end 171 leftward. The handrail 112 may be disengaged entirely, or may be rotated about the lock nut 170 or lock stud 168 into a convenient orientation when the middle step 108 and the bottom step 110 are folded beneath the top step 102 as described later herein. Either the lock nut 170 or the lock stud 168 may be made to provide moderate resistance to disengagement if complete disengagement of the handrail portion 112 is considered undesirable.

With reference to FIGS. 8, 9, 10 and 11, the right and left attachment brackets 114 and 116 can permanently attach the catwalk 102 to the frame or any other sturdy and appropriately located structure within the engine compartment of the tractor. The L-pins 118 pass through the mounting bushings 146 and the catwalk bushings 142, transferring loads from the catwalk bushings 142 to the mounting 104, while permitting the catwalk to be rotated upward if desired, so long as the slide locks 134 beneath the catwalk 102 are disengaged from the mount lock plate 144.

With reference to FIGS. 11 and 12, the hinge 120 permanently joins a portion of the top step upper surface 107 proximate the top step rear 150, to the catwalk upper surface 103 proximate the catwalk front 148, while allowing the top step 106 to rotate upward and rearward about the hinge 120 until the top step upper surface 107 abuts the catwalk upper surface 103, provided the slide locks 134 of the top step 106 are first disengaged from the lock plates 138 of the catwalk 102.

With reference to FIG. 8, the catwalk 102 and the top step 106 together provide a flat surface on which a person may sit, stand or crawl to reach areas of the engine compartment. This flat surface is firmly attached to the frame of the tractor via the mounting 104; the top step 106 rests on the topmost tread portion of the tractor tire. The middle step 108, bottom step 10 and handrail 112 facilitate climbing onto the top step 106.

With continued reference to FIG. 8, the right and left lower angle arms 124 and 130, the right and left straight arms 126 and 132, and the bottom step 110 are linked in a manner permitting the bottom step 110 to be nested compactly within and beneath the middle step 108. The handrail 112 may be disengaged from the middle step 108 as already described with reference to FIGS. 12, 13 and 15. The middle step 108, left and right upper angle arms 128 and 122 and top step 106 are linked in a manner permitting the middle step 108 to be nested compactly within and beneath the top step 106. The top step 106 may then be rotated until the top step upper surface 107 abuts the catwalk upper surface 103. The handrail 112, if it remains engaged with the top step 106, may be rotated about the lock stud 168 to a convenient orientation. The straight arms 126 and 132 and lower angle arms 124 and 130 are short enough to nest beneath the middle step 108 along with the bottom step 110. The upper angle arms 128 and 122 are short enough to nest beneath the top step 106 along with the middle step 108. As a result, this embodiment of the accessory in accordance with the present invention folds compactly when not in use, so that the cab may be lowered and the tractor may be operated without removing the accessory from the tractor. If desired, accessories may be installed on both sides of the tractor engine compartment for greater convenience.

### Fifth Exemplary Embodiment

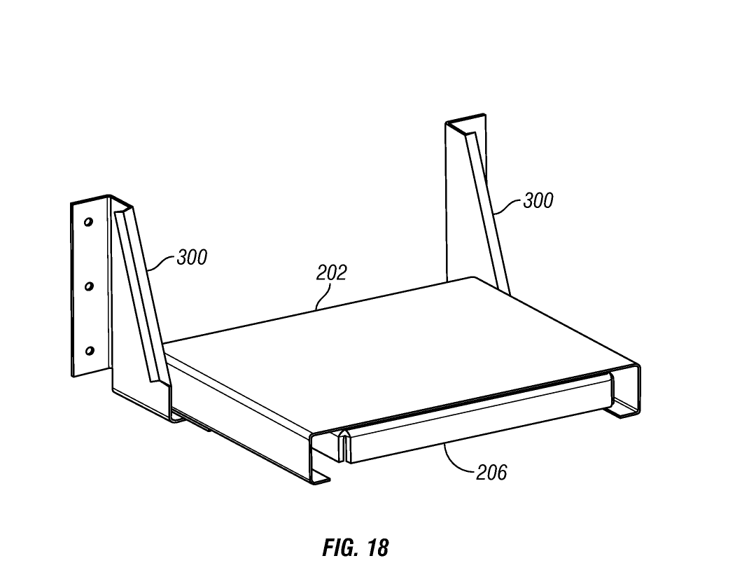

FIG. 16, a perspective view of a fifth exemplary embodiment of the service accessory in accordance with the present invention, shows a pair of gussets 300, a catwalk 202 rotatably attached to the gussets, a large step 206 suspended beneath the catwalk 202, and a small step 210 attached via shoulder bolts or dowel pins 260 to arms 226 and 232, which are themselves attached via shoulder bolts or dowel pins 266 to bent arms 224 and 230, which are themselves attached via shoulder bolts or dowel pins 264 to the large step 206. This exemplary embodiment of the service accessory in accordance with the present invention is securable to a tractor frame, collapsible to compact nested configuration, and rotatable upward, as is the exemplary embodiment of FIGS. 8-15, but has fewer steps and utilizes the gussets 300, which are bored to receive bolts for attachment to the tractor frame, instead of a mounting 104. Another variation is that the large step 206 is movably secured to the catwalk 202 in any of a variety of ways: a hinge 120 (FIG. 8) allowing upward folding and slide locks 134 (FIG. 8) for stabilization; or a heavy-duty sliding-drawer wheel-and-track structure, or sliding track structure, capable of carrying heavy weight and capable of locking in extended and retracted positions (not shown).

FIG. 17, a perspective view of the embodiment of FIG. 16 with small step nested beneath large step, shows the accessory in an early stage of the process of collapsing and securing.

FIG. 18, a perspective view of the embodiment of FIG. 16 with large step nested beneath catwalk, shows a later stage of that process.

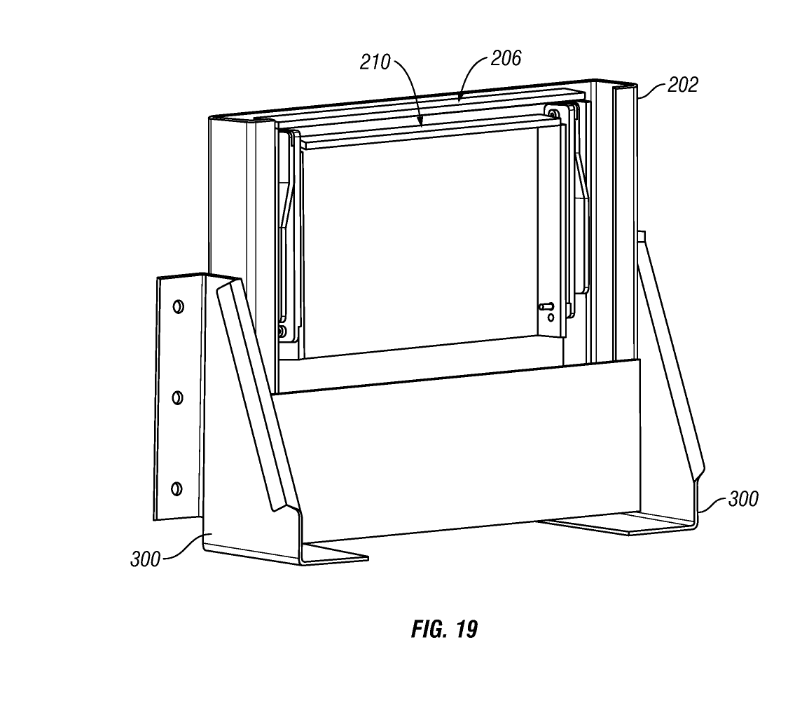

FIG. 19, a perspective view of the embodiment of FIG. 16 with steps rotated upward between gussets, shows a late stage of that process.

The accessory in accordance with the present invention is made of aircraft aluminum suitably cut, formed, bent and machined; however, it may be made of steel or other strong, durable, and preferably corrosion-resistant combination of materials, including high-strength composites, or a mixture of composites and metals.

Non-skid material or a non-skid surface treatment is recommended for the upward facing load-bearing surfaces of the accessory in accordance with the present invention, and may also be applied to the handrail 112 and manually grasped portions of the L-pins 118.

### Concerning the Exemplary Embodiments Generally

As can be seen from the drawing figures and from the description, each exemplary embodiment of the service accessory in accordance with the present invention solves a problem by addressing the need for a safe, simple, compact, convenient, durable means of climbing onto a tractor to work in the engine compartment.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. For example, the number of steps may be varied; the number and placement of the handrails may be varied. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

What is claimed is:

1. A service accessory for a truck tractor, the accessory comprising:
a mounting for attachment to a structure of the tractor;
a catwalk extending laterally from said mounting;
a top step extending laterally from said catwalk and capable of resting atop a tire of a wheel of the tractor; and
at least one step suspended from said top step,
said mounting, catwalk, top step, and at least one suspended step being linked such that said at least one suspended step is nestable beneath said top step, said top step is configurable to an orientation above and adjacent to said catwalk, and said catwalk is configurable to an orientation above said mounting.

2. The service accessory as set forth in claim 1, wherein said steps are linked together in a manner limiting the range of rotation of said at least one suspended step in a manner preventing said step from opening to an angle beyond approximately horizontal while suspended.

3. The service accessory as set forth in claim 2, wherein the range of rotation of at least one of said at least one steps is limited by mechanical interference between a dowel pin and a shoulder.

4. A service accessory for gaining access to an engine compartment of a truck tractor, the accessory comprising:
a substantially flat and substantially level portion supported inboard by a structural member of the tractor and supported outboard by a tire of said tractor;
at least one step suspended from said level portion,
said level portion and said at least one step being configurable together to permit closure of the engine compartment of the tractor and normal operation of the tractor.
